(19) United States
(12) Patent Application Publication
(10) Pub. No.: US 2024/0214157 A1
(43) Pub. Date: Jun. 27, 2024

(54) SIGNALING METHODS FOR DYNAMICALLY SWITCHING TCI STATES BETWEEN SINGLE TRP OPERATION AND MULTI TRP OPERATION

(71) Applicants: Centre of Excellence in Wireless Technology, Taramani (IN); Indian Institute of Technology Madras, Chennai (IN)

(72) Inventors: Vishakha Singh, Chennai (IN); Thirunageswaram Ramachandran Ramya, Chennai (IN); Jeniston Deviraj Klutto Milleth, Chennai (IN); Bhaskar Ramamurthi, Chennai (IN)

(21) Appl. No.: 18/395,092

(22) Filed: Dec. 22, 2023

(30) Foreign Application Priority Data
Dec. 23, 2022 (IN) 202241075009

(51) Int. Cl. H04L 5/00; H04W 72/231

(52) U.S. Cl. CPC H04L 5/0053; H04L 5/0035; H04W 72/231

(57) ABSTRACT

A method for performing signaling in a multi Transmission/Reception Point (TRP) wireless communication system is described. The method comprises receiving, by a second node (104), a Medium Access Control-Control Element (MAC-CE) from a first node (102). The MAC-CE comprises a code-point. The code-point maps to a Transmission Configuration Indicator (TCI) state. The second node (104) receives at least one of a flag, TCI field, TCI selection field, signaling index and an index of a bit map from a plurality of bit maps in a Downlink Control Information (DCI) from the first node (102). The TCI field comprises at least one bit to indicate the code-point of the MAC-CE. The second node (104) activates the TCI state based on the DCI. The second node (104) performs at least one of a Downlink (DL) reception and an Uplink (UL) transmission using the TCI state activated.

### CROSS-REFERENCE TO RELATED APPLICATIONS

This application claims priority pursuant to India Patent Application No. 202241075009, filed Dec. 23, 2022, which application is incorporated herein by reference in its entirety.

### FIELD OF THE INVENTION

The present invention relates to a wireless communication system, and more particularly to signaling methods for dynamically switching Transmission Configuration Indicator (TCI) states between single Transmission/Reception Point (TRP) operation and multi TRP operation in the wireless communication system.

### BACKGROUND OF THE INVENTION

Fifth Generation (5G) wireless networks are expected to support massive connectivity, high capacity, ultra-reliability, and low latency. Such diverse use case scenarios require diverse approaches for the realization of future 5G systems. Rel-15 New Radio (NR) includes several Multiple-Input Multiple-Output (MIMO) features that facilitate utilization of a large number of antenna elements at base station for both sub-6 GHz and over-6 GHz frequency bands. Rel-16 NR extended the features of Rel-15 by introducing support for Multi-Transmission/Reception Point (TRP) transmission especially for Enhanced mobile broadband (eMBB) Physical Downlink Shared Channel (PDSCH), enhancements for multi-beam operation including reduction in latency and/or overhead for various reconfigurations.

Quasi co Location (QCL) was introduced in Fourth Generation (4G) and beyond systems. As per the 3rd Generation Partnership Project (3GPP) two Reference Signals (RSs) can have a QCL relationship, where QCL is defined as “Two antenna ports are said to be quasi co-located if properties of the channel over which a symbol on one antenna port is conveyed can be inferred from the channel over which a symbol on the other antenna port is conveyed”. The two RSs are said to be quasi co-located (QCLed) if large-scale channel properties of one RS can be inferred from the other RS. There are various types of QCL depending on the large-scale parameters that are common between the QCLed RS signals. The QCL helps the User Equipment (UE) to infer the channel conditions of one RS based on the channel conditions of the other (QCLed) RS. In NR, the quasi co-location relationship is configured by the higher layer parameter qcl-Type1 for the first Downlink (DL) RS, and qcl-Type2 for the second DL RS. There is need for selecting multiple potential QCL configurations due to the requirement of advanced beam management and introduction of features such as multi TRP. To enable multiple configurations of the QCL relations between RSs, a list of Transmission Configuration Indicator (TCI) states are introduced in the NR. The TCI state contains information of a source RS, target RS and the QCL relation (QCL Type) between them.

In NR, there are three different configuration mechanisms to associate a TCI state to a target RS, such as (i) Radio Resource Control (RRC) for periodic Channel State Information Reference Signal (CSI-RS), (ii) Medium Access Control-Control Element (MAC-CE) for Physical Downlink Control Channel Demodulation Reference Signal (PDCCH DM-RS) or Semi-persistent (SP) CSIRS and (iii) Downlink Control Information (DCI) for Physical Downlink Shared Channel Demodulation Reference Signal (PDSCH DM-RS) and for aperiodic CSI-RS. In addition, there exists a default QCL relation between PDCCH DM-RS, PDSCH DM-RS, and the Synchronization Signal Block (SSB) before the RRC configuration comprising a list of TCI states. These default QCL relations are used in the initial access procedure. The RRC configures a maximum of 128 TCI states to the UE. The MAC-CE selects either one or multiple TCI states from the 128 TCI states configured by the RRC. The scheduling DCI selects one of the multiple activated TCI states. In the case of the PDCCH DM-RS, a single TCI state is selected and activated by the MAC-CE. In the case of the PDSCH DM-RS, multiple TCI states are selected using the MAC-CE and one among them is activated using the DCI. The same TCI state can be configured for PDSCH DM-RS and the PDCCH that schedules the PDSCH.

To enable a gNB to prepare a good receive (RX) beam that corresponds to the UE transmission, there is a functionality referred to as spatial relation. A spatial relation is defined on the UE side while the QCL is defined on the gNB side (as observed at the UE). Hence, similar to configuring QCL relations by the TCI states for the DL transmissions, a list of spatial relations is configured for the UL transmissions. For UL, the spatialRelationInfo is used for beam indication for Physical Uplink Control Channel (PUCCH) and Sounding Reference Signal (SRS), which is updated through the RRC and the MAC-CE signaling. For Physical Uplink Shared Channel (PUSCH), the SRS Resource Indicator (SRI) is signaled in an Uplink (UL) DCI with UL grants and is used for beam indication.

Release 16 extends the NR with the support for DL multi-TRP transmission to transmit PDSCH simultaneously from two geographically separated TRPs. The two TRPs, for example, correspond to different physical cell sites but from a device point-of-view, the multi-point transmission will still be considered originating from a single logical cell. There are several potential advantages with multi-TRP transmission. The multi-TRP transmission is used to extend the overall transmission power available for downlink transmission to a single device by utilizing the total power available at multiple transmission points. The multi-TRP transmission is also used to extend the overall rank of the channel when the rank from a single transmission point is limited, for example, due to line-of-sight propagation conditions. In 3GPP Rel-15/Rel-16, the scheme for beam indication is designed independently for each channel/RS.

In order to reduce the signalling overhead of beam indication, unified TCI framework has been included for single TRP in Rel 17, in which the single common beam is used to indicate the beam for different data/channels/RSs. Rel 17 Unified TCI framework for single TRP includes both ‘joint TCI for DL and UL’ and ‘separate TCI for UL and DL’ transmission/reception. Currently in Rel 18, the unified TCI framework is extended to multi TRP architecture to enable further reduction in the overhead of beam indication for multi-TRP. In high mobility scenarios where UE is required to frequently switch across TRPs for better connection and the scenarios where the traffic loads need to be distributed across the TRPs and requires network scheduling flexibility, there is a need to support dynamic switching between single TRP and multi TRP transmission.

Thus, there is a need for the present invention to provide signalling methods required to support dynamic switching between single TRP and multi TRP in order to avoid large delays and risk of RRC signalling storm associated with RRC reconfiguration.

### OBJECTS OF THE INVENTION

A general objective of the present invention is to provide signaling methods for dynamically switching Transmission Configuration Indicator (TCI) states between single Transmission/Reception Point (TRP) operation and multi TRP operation in a wireless communication system.

Another objective of the invention is to provide signalling methods to provide better connection and network scheduling flexibility of the wireless communication system.

Another objective of the invention is to provide signalling methods to avoid large delays and risk of RRC signaling storm associated with RRC reconfiguration in the wireless communication system.

### SUMMARY OF THE INVENTION

The summary is provided to introduce aspects related to channel bandwidth adaptation in a cellular network, and the aspects are further described below in the detailed description. This summary is not intended to identify essential features of the claimed subject matter nor is it intended for use in determining or limiting the scope of the claimed subject matter.

In one embodiment, a method for performing signaling in a multi Transmission/Reception Point (TRP) wireless communication system is described. The method comprises receiving, by at least one second node, at least one Medium Access Control-Control Element (MAC-CE) from at least one first node. The at least one MAC-CE comprises at least one code-point and the at least one code-point maps to at least one Transmission Configuration Indicator (TCI) state. The method further comprises receiving, by the at least one second node, at least one of a flag and TCI field in at least one Downlink Control Information (DCI) from the at least one first node. The flag comprises at least one bit to indicate one of a single TRP and a multi TRP operation from the at least one first node. The TCI field comprises at least one bit to indicate the at least one code-point of the at least one MAC-CE. The method further comprises activating, by the at least one second node, the at least one TCI state based on at least one of the flag and the TCI field. The method further comprises performing, by the at least one second node, at least one of at least one Downlink (DL) reception and at least one Uplink (UL) transmission using at least one TCI state activated.

In one aspect, the MAC-CE is at least one of a single TRP MAC-CE and a multiple TRP MAC-CE.

In one aspect, the at least one TCI state belongs to a unified TCI state.

In one aspect, the at least one DL reception is at least one of Physical Downlink Control Channel (PDCCH), Physical Downlink Shared Channel (PDSCH), and DL reference signals.

In one aspect, the at least one UL transmission is at least one of Physical Uplink Control Channel (PUCCH), Physical Uplink Shared Channel (PUSCH), and UL reference signals.

In one aspect, the at least one code-point of the at least one MAC-CE is mapped to the at least one of one TCI state, two TCI states, three TCI states and four TCI states.

In one aspect, the at least one code-point is mapped to the at least one TCI state from at least one of at least one joint/DL TCI states and at least one UL TCI state.

In one aspect, the at least one MAC-CE comprises at least one of serving cell identity (ID), Bandwidth Part Indicator (BWP ID), at least one Reserved bit (R) field, at least one joint/DL TCI state ID field, at least one UL TCI state ID field, at least one Aᵢ field and at least one D/Uᵢ field, at least one B_{i,j} field, at least one Cᵢ field, and at least one D _{i, j} field.

In one aspect, the at least one code-point of the at least one MAC-CE is applied to the BWP ID comprising at least one of DL BWP and UL BWP.

In one aspect, the at least one Aᵢ field indicates whether ith TCI code-point maps to any one of single and multiple TCI states from at least one of the at least one joint/DL TCI state and the at least one UL TCI state.

In one aspect, the at least one D/Uᵢ field indicates whether ith TCI code-point maps to at least one TCI state from at least one of the at least one joint/DL TCI state and the at least one UL TCI state.

In one aspect, at least one code-point is determined by its ordinal position among all TCI state fields.

In one aspect, the at least one B_{i,j} field indicates at least one code-point indicating at least one UL TCI state ID field is present.

In one aspect, the at least one Cᵢ field indicates at least one code-point indicating at least one joint/DL TCI state ID field is present.

In one aspect, the at least one D_{i,j} field indicates whether preceding octet is one of padding octet and the at least one joint/DL TCI state.

In one aspect, the at least one joint/DL TCI state ID field indicates the at least one joint/DL TCI state from a plurality of joint/DL TCI states configured for the at least one second node.

In one aspect, the at least one UL TCI state ID field indicates the at least one UL TCI state from a plurality of UL TCI states configured for the at least one second node.

In one embodiment, a method for performing signaling in the multi TRP wireless communication system is described. The method comprises receiving, by at least one second node, at least one MAC-CE from at least one first node. The at least one MAC-CE comprises at least one code-point and the at least one code-point maps to at least one TCI state. The method further comprises receiving, by the at least one second node, at least one of TCI field and TCI selection field in at least one DCI from the at least one first node. The TCI field comprises at least one bit to indicate the at least one code-point of the at least one MAC-CE. The method further comprises activating, by the at least one second node, the at least one TCI state based on at least one of the TCI field and the TCI selection field. The method further comprises performing by the at least one second node, at least one of at least one Downlink (DL) reception and at least one Uplink (UL) transmission using the at least one TCI state activated.

In one aspect, the TCI selection field indicates the at least one TCI state corresponding to the at least one code-point indicated using the TCI field in the DCI to the at least one second node.

In one aspect, the TCI selection field implicitly or explicitly indicates at least one of a single TRP operation and a multi TRP operation.

In one aspect, the TCI selection field is signaled using at least one of Radio Resource Control (RRC) and Medium Access Control-Control Element (MAC-CE) based signaling.

In one aspect, the TCI selection field is a bit map with length of maximum number of TCI states per code-point present in the at least one MAC-CE

In one aspect, the at least one code-point is mapped to the at least one TCI state from at least one of at least one joint/DL TCI state and at least one UL TCI state.

In one aspect, the at least one TCI state applies to at least one of the at least one UL transmission and at least one DL reception.

In one aspect, the at least one DL reception and the at least one UL transmission is at least one of Physical Downlink Control Channel (PDCCH), Physical Downlink Shared Channel (PDSCH), Physical Uplink Control Channel (PUCCH), Physical Uplink Shared Channel (PUSCH) and at least one reference signal.

In one aspect, the at least one TCI state belongs to a unified TCI state.

In one embodiment, a method for performing signaling in the multi TRP wireless communication system is described. The method comprises receiving, by at least one second node, at least one MAC-CE from at least one first node. The at least one MAC-CE comprises at least one code-point and the at least one code-point maps to at least one TCI state. The method further comprises receiving, by the at least one second node, at least one of TCI field and signaling index in at least one DCI from the at least one first node. The TCI field comprises at least one bit to indicate at least one code-point of the at least one MAC-CE. The method further comprises activating, by the at least one second node, the at least one TCI state based on at least one of the signaling index and the TCI field. The method further comprises performing, by the at least one second node, at least one of at least one Downlink (DL) reception and at least one Uplink (UL) transmission using the at least one TCI state activated.

In one aspect, the signaling index indicates the at least one TCI state corresponding to the at least one code-point indicated using the TCI field in the at least one DCI to the at least one second node

In one aspect, the signaling index is signaled using at least one of Radio Resource Control (RRC) and Medium Access Control-Control Element (MAC-CE) based signaling.

In one aspect, the at least one code-point is mapped to the at least one TCI state from at least one of at least one joint/DL TCI state and at least one UL TCI state.

In one aspect, the at least one TCI state applies to at least one of the at least one DL reception and the at least one UL transmission.

In one aspect, the at least one DL reception and the at least one UL transmission is at least one of Physical Downlink Control Channel (PDCCH), Physical Downlink Shared Channel (PDSCH), Physical Uplink Control Channel (PUCCH), Physical Uplink Shared Channel (PUSCH), and at least one reference signal.

In one aspect, wherein the length of the signaling index is (n+1), where n=log 2 (maximum number of TCI states in the at least one code-point).

In one aspect, at least one bit in the signaling index implicitly or explicitly indicates one of a single TRP operation and a multi TRP operation.

In one aspect, for explicit indication, the at least one bit is a Most Significant Bit (MSB) or a Least Significant Bit (LSB) of the (n+1) bits.

In one aspect, when the single TRP operation is indicated, remaining bits in the signaling index activates the at least one TCI state corresponding to the at least one code-point in the at least one DCI.

In one aspect, when the multi TRP operation is indicated, the remaining bits in the signaling index activates all TCI states corresponding to the at least one code-point indicated by the TCI field in the at least one DCI.

In one aspect, wherein the at least one TCI state belongs to a unified TCI state.

In one embodiment, a method for performing signaling in the multi TRP wireless communication system is described. The method comprises receiving, by at least one second node, at least one MAC-CE from at least one first node. The at least one MAC-CE comprises at least one code-point and the at least one code-point maps to at least one TCI state. The method further comprises receiving, by the at least one second node, a TCI field and at least one index of at least one bit map from a plurality of bit maps in at least one DCI from the at least one first node. The TCI field comprises at least one bit to indicate the at least one code-point of the at least one MAC-CE. The method further comprises activating, by the at least one second node, the at least one TCI state based on at least one of the at least one index of the at least one bit map from the plurality of bit maps and the TCI field. The method further comprises performing, by the at least one second node, at least one of at least one Downlink (DL) reception and at least one Uplink (UL) transmission using the at least one TCI state activated.

In one aspect, the at least one bit map indicates the at least one TCI state corresponding to the code-point indicated using TCI field in the at least one DCI to the at least one second node.

In one aspect, the at least one index of the at least one bit map from the plurality of bit map implicitly or explicitly indicates at least one of a single TRP and a multi TRP operation.

In one aspect, the at least one bit map is signaled using at least one of Radio Resource Control (RRC) and Medium Access Control-Control Element (MAC-CE) based signaling.

In one aspect, length of the at least one bit map is maximum number of TCI states per code-point present in the at least one MAC-CE.

In one aspect, the at least one code-point is mapped to the at least one TCI state from at least one of at least one joint/DL TCI state and at least one UL TCI state.

In one aspect, the at least one TCI state applies to at least one of the at least one DL reception and the at least one UL transmission.

In one aspect, the at least one DL reception and the at least one UL transmission is at least one of Physical Downlink Control Channel (PDCCH), Physical Downlink Shared Channel (PDSCH), Physical Uplink Control Channel (PUCCH), Physical Uplink Shared Channel (PUSCH), and at least one reference signal.

In one aspect, position of bits in the at least one bitmap field represents the at least one TCI state activated.

In one aspect, the at least one TCI state belongs to a unified TCI state.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 illustrates an architecture of a cellular network for providing communication between a Transmission/Reception Points (TRP) and User Equipments (UE), in accordance with an embodiment of the present invention.

FIG. 2 illustrates a flow chart of a method for performing signaling in a multi TRP wireless communication system, in accordance with an embodiment of the present invention.

FIG. 3 illustrates a Medium Access Control-Control Element (MAC-CE) structure for single TRP operation, in accordance with an embodiment of the present invention.

FIG. 4 illustrates a Medium Access Control-Control Element (MAC-CE) structure for multi TRP operation, in accordance with an embodiment of the present invention.

FIG. 5 illustrates a flow chart of a method for performing signaling in a multi TRP wireless communication system, in accordance with an embodiment of the present invention.

FIG. 6 illustrates a flow chart of a method for performing signaling in a multi TRP wireless communication system, in accordance with an embodiment of the present invention.

FIG. 7 illustrates a flow chart of a method for performing signaling in a multi TRP wireless communication system, in accordance with an embodiment of the present invention.

FIG. 8 illustrates Code point representation in MAC-CE structure, in accordance with an embodiment of the present invention.

FIG. 9 illustrates a look up table, in accordance with an embodiment of the present invention.

### DETAILED DESCRIPTION OF THE INVENTION

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. This disclosure may however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

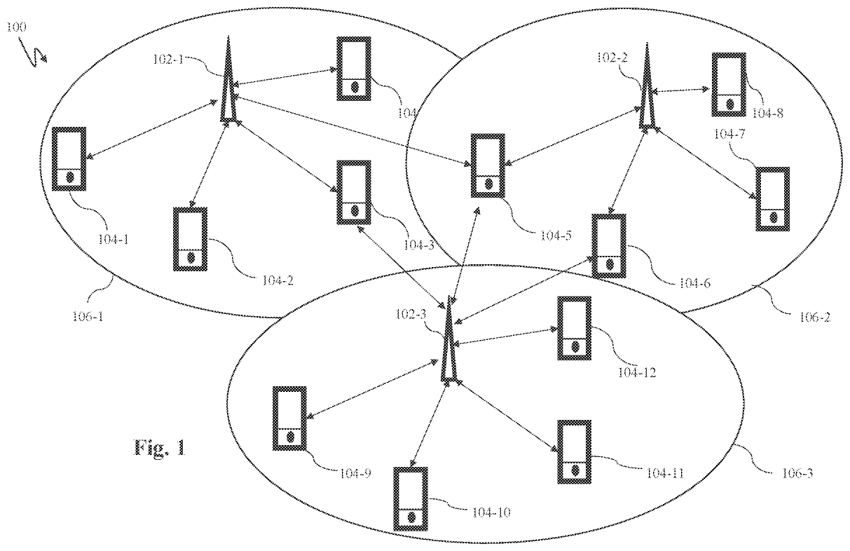

FIG. 1 illustrates an architecture of a cellular network 100 for providing communication between a Transmission/Reception Point (TRP) 102-1, 102-2, 102-3 and User Equipments (UEs) 104-1 to 104-12, in accordance with an embodiment of the present invention. As illustrated in FIG. 1, the UEs 104-1 to 104-4 may be present in a coverage area 106-1 of the TRP 102-1, the UEs 104-5 to 104-8 may be present in a coverage area 106-2 of the TRP 102-2, and the UEs 104-9 to 104-12 may be present in a coverage area 106-3 of the TRP 102-3. Henceforth, based on requirements, the UE 104-1 to 104-12 may be collectively referred as the UE 104. Similarly, the TRP 102-1 to 102-3 may be collectively referred as the TRP 102. The UE 104 may communicate with the TRP 102.

The present invention relates to signaling methods for dynamically switching Transmission Configuration Indicator (TCI) states between single TRP operation and multi TRP operation in the wireless communication network 100.

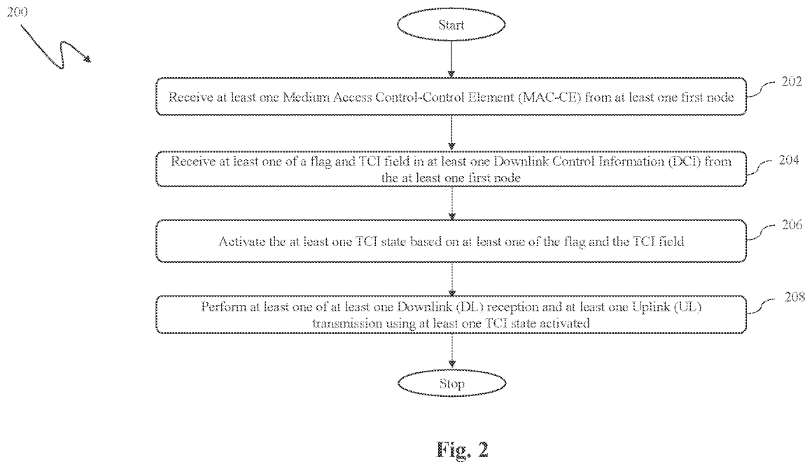

FIG. 2 illustrates a flow chart of a method for performing signaling in a multi TRP wireless communication system, in accordance with an embodiment of the present invention. It should also be noted that in some alternative implementations, the functions noted in the blocks may occur out of the order noted in the drawings. For example, two blocks shown in succession in FIG. 2 may in fact be executed substantially concurrently or the blocks may sometimes be executed in the reverse order, depending upon the functionality involved. Alternate implementations are included within the scope of the example embodiments in which functions may be executed out of order from that shown or discussed, including substantially concurrently or in reverse order, depending on the functionality involved.

The UE 104 may receive at least one Medium Access Control-Control Element (MAC-CE) from the TRP 102, at step 202. The at least one MAC-CE may comprise at least one code-point. The at least one code-point may map to at least one Transmission Configuration Indicator (TCI) state. The UE 104 may receive at least one of a flag and TCI field in at least one Downlink Control Information (DCI) from the TRP 102, at step 204. The flag may comprise at least one bit to indicate one of a single TRP and a multi TRP operation from the TRP 102. The TCI field may comprise at least one bit to indicate the at least one code-point of the at least one MAC-CE. The UE 104 may activate the at least one TCI state based on at least one of the flag and the TCI field, at step 206. The UE 104 may perform at least one of at least one Downlink (DL) reception and at least one Uplink (UL) transmission using at least one TCI state activated, at step 208.

The MAC-CE may be at least one of a single TRP MAC-CE and a multiple TRP MAC-CE. The at least one TCI state may belong to a unified TCI state. The at least one DL reception may be at least one of Physical Downlink Control Channel (PDCCH), Physical Downlink Shared Channel (PDSCH), and DL reference signals. The at least one UL transmission may be at least one of Physical Uplink Control Channel (PUCCH), Physical Uplink Shared Channel (PUSCH), and UL reference signals.

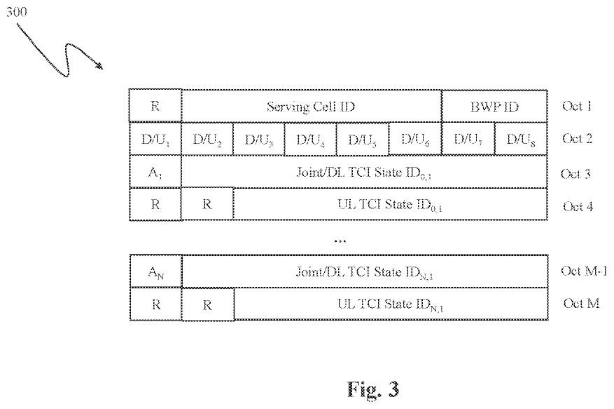

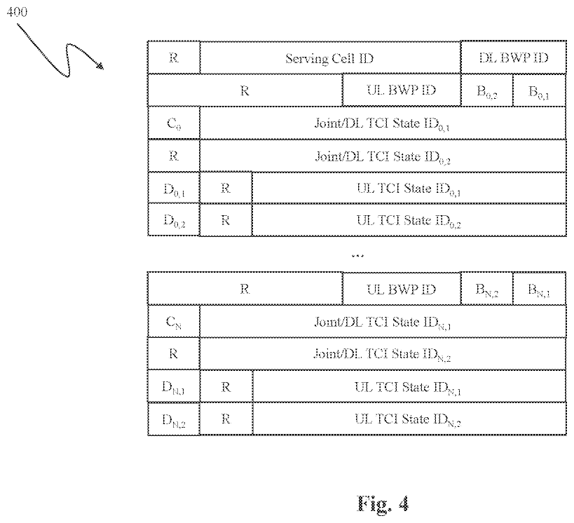

FIG. 3 illustrates a MAC-CE structure for single TRP operation, in accordance with an embodiment of the present invention. In the MAC-CE signalled for single TRP operation, the at least one code-point in the at least one MAC-CE may map to at least one joint/DL and/or one UL TCI state. FIG. 4 illustrates a Medium Access Control-Control Element (MAC-CE) structure for multi TRP operation, in accordance with an embodiment of the present invention. In the MAC-CE signaled for multi TRP operation, the at least one code-point may map to multiple joint/DL/UL TCI states.

The TRP 102 may signal both single TRP MAC-CE and multi TRP MAC-CE to the UE 104 to support dynamic switching between single TRP and multi TRP. The TRP 102 may indicate through the at least one DCI, whether to perform single TRP operation or multi TRP operation. For example, the TRP 102 may include a one-bit flag or group of bits flag in the DCI to indicate whether the operation is a single TRP or a multi TRP operation. If the flag is 0 (or 1), the TCI-field in the DCI may map to the corresponding code-point in the MAC-CE corresponding to single TRP i.e., only one TCI state indicated by the code-point may be activated. If the flag is 1 (or 0), the TCI-field in the DCI may map to the corresponding code-point in the MAC-CE corresponding to multi TRP i.e., multiple TCI states indicated by the code-point may be activated. Alternatively, flag equal to 1 (or 0) may indicate a single TRP operation, while bit field equal to 0 (or 1) may indicate a multi TRP operation. Hence, using the method as illustrated in FIG. 2, the TRP 102 may switch the UE 104 between single TRP operation and multi TRP operation dynamically.

As illustrated in FIGS. 3 and 4, the at least one MAC-CE may comprise information of at least one of serving cell identity (ID), Bandwidth Part Indicator (BWP ID), at least one Reserved bit (R) field, at least one joint/DL TCI state ID field, at least one UL TCI state ID field, at least one Aᵢ field and at least one D/Uᵢ field, at least one B_{i,j} field, at least one Cᵢ field, and at least one D_{i,j} field. The BWP ID may comprise at least one of DL BWP and UL BWP.

The information in MAC-CE may be arranged in the form of octets and reserved bits ‘R’ may be used to complete the octet, if needed. In the single TRP MAC-CE structure as illustrated in FIG. 3, the field Aᵢ may indicate whether i^{th} TCI code-point has multiple TCI states or single TCI state. If the Aᵢ field is set to 1 (or 0), the field may indicate that it^{h} TCI code-point may include the DL TCI state and the UL TCI state. If the Aᵢ field is set to 0 (or 1), the field may indicate that i^{th} TCI code-point may include only the DL/joint TCI state or the UL TCI state.

As shown in FIG. 3, the field D/Uᵢ may indicate whether the TCI state ID in the first octet may be for joint/downlink or uplink TCI state. If this field is set to 1 (or 0), the TCI state ID in the first octet may be for joint/downlink. If this field is set to 0 (or 1), the TCI state ID in the first octet may be for uplink. The code-point to which a TCI state is mapped may be determined by its ordinal position among all the TCI state ID fields.

If the Aᵢ field indicates that the i^{th} TCI code-point may indicate the DL TCI state and the UL TCI state and if the field D/Uᵢ may indicate the first octet may be the DL TCI state, then the second octet may be the UL TCI state. If the Aᵢ field indicates that the i^{th} TCI code-point may indicate the DL TCI state and the UL TCI state and if the field D/Uᵢ may indicate the first octet may be the UL TCI state, then the second octet may be the DL TCI state. If the Aᵢ field indicates that the i^{th} TCI code-point may include either the DL TCI state or the UL TCI state, then the field D/Uᵢ may indicate whether the code-point may include DL TCI state or UL TCI state.

In the multi TRP MAC-CE shown in FIG. 4, MAC-CE structure may consist of the fields for supporting unified TCI framework for multi TRP operation. The field DL BWP ID may indicate the DL BWP for which the code-point in MAC-CE may be applied as the code-point of the DCI BWP field as specified in TS 38.212. The length of the DL BWP ID field may be 2 bits. The field UL BWP ID may indicate the UL BWP for which the MAC-CE may be applied as the code-point of the DCI BWP field as specified in TS 38.212. The length of the UL BWP ID field may be 2 bits.

The field Cᵢ may indicate whether the octet containing joint/DL TCI state ID_{i,j} is present. If this field is set to “1 (or 0)”, the octet containing TCI state ID_{i,j} may be present. If this field is set to “0 (or 1)”, the octet containing TCI state ID_{i,j} may not be present. The field Joint/DL TCI state ID_{i,j} may indicate one joint/DL unified TCI state configured for the UE 104 out of the 128 Joint/DL TCI states configured for the UE 104. The field B_{i,j} may indicate whether the octet containing UL TCI state ID_{i,j} is present. If this field is set to “1 (or 0)”, the octet containing UL TCI state ID_{i,j} may be present. If this field is set to “0 (or 1)”, the octet containing UL TCI state ID_{i,j}may not be present. The filed UL TCI state ID_{i,j} may indicate one UL unified TCI state configured for the UE 104 out of the 64 UL TCI states configured for the UE 104. The field Dᵢⱼ may indicate whether the UE 104 should consider the preceding octet as padding or as the DL TCI state.

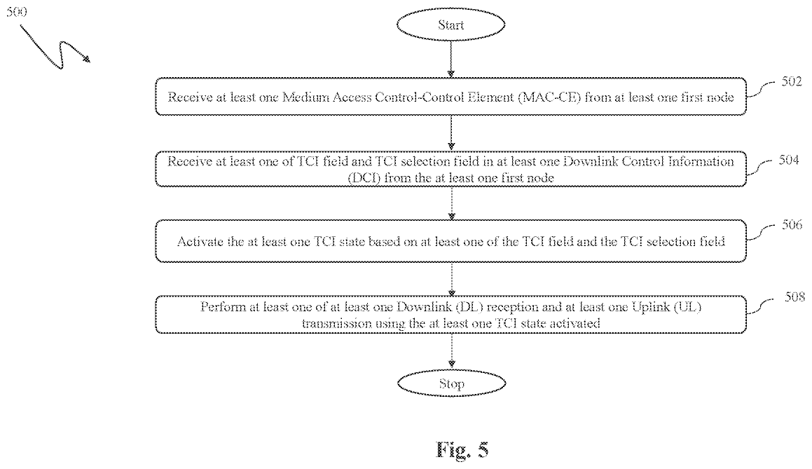

FIG. 5 illustrates a flow chart of a method for performing signaling in a multi TRP wireless communication system, in accordance with an embodiment of the present invention. It should also be noted that in some alternative implementations, the functions noted in the blocks may occur out of the order noted in the drawings. For example, two blocks shown in succession in FIG. 5 may in fact be executed substantially concurrently or the blocks may sometimes be executed in the reverse order, depending upon the functionality involved. Alternate implementations are included within the scope of the example embodiments in which functions may be executed out of order from that shown or discussed, including substantially concurrently or in reverse order, depending on the functionality involved.

The UE 104 may receive the at least one MAC-CE from the TRP 102, at step 502. The at least one MAC-CE may comprise at least one code-point. The at least one code-point may map to the at least one TCI state. The UE 104 may receive at least one of TCI field and TCI selection field in the at least one DCI from the TRP 102, at step 504. The TCI field may comprise at least one bit to indicate the at least one code-point of the at least one MAC-CE. The UE 104 may activate the at least one TCI based on at least one of the TCI field and the TCI selection field, at step 506. The UE 104 may perform at least one of the at least one DL reception and the at least one UL transmission using at least one TCI state activated, at step 508.

The TCI selection field may indicate the at least one TCI state corresponding to the at least one code-point indicated using the TCI field in the DCI to the UE 104. The TCI selection field may indicate at least one of a single TRP operation and a multi TRP operation implicitly or explicitly. The TRP 102 may signal the TCI selection field using at least one of Radio Resource Control (RRC) and MAC-CE based signaling. The TCI selection field may be a bit map with length of maximum number of TCI states per code-point present in the at least one MAC-CE.

The TRP 102 may signal the bitmap in the DCI to dynamically switch the UE 104 between single TRP and multi TRP operation. The UE 104 may be signalled with the MAC-CE. The MAC-CE may contain multiple code-points and each code-point may map to multiple DL/Joint/UL TCI states. A TCI field in the DCI may activate the UE 104 with one of the code-points. The code-point may map to multiple TCI states. The TRP 102 may signal another bitmap in the DCI, which may activate the subset of TCI states present in the activated code-point. For example, if the activated code-point contains 4 TCI states namely, TCI 1, TCI 2, TCI 3 and TCI 4 and if the indicated bitmap in DCI is 1010, then TCI 1 and TCI 3 may be activated for the UE 104.

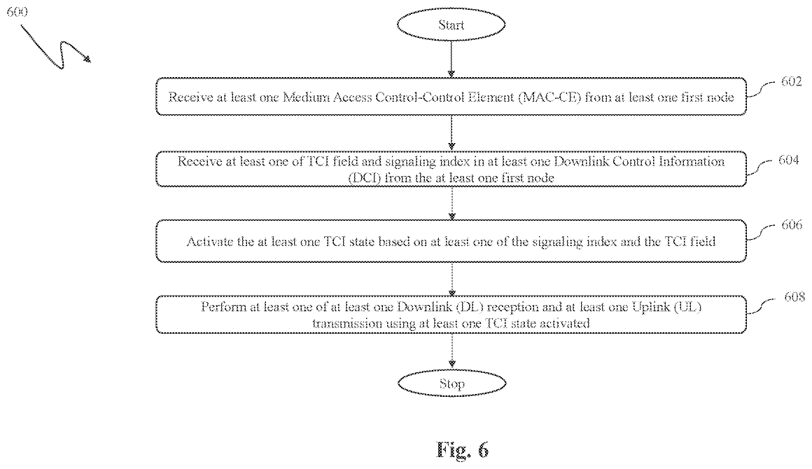

FIG. 6 illustrates a flow chart of a method for performing signaling in a multi TRP wireless communication system, in accordance with an embodiment of the present invention. It should also be noted that in some alternative implementations, the functions noted in the blocks may occur out of the order noted in the drawings. For example, two blocks shown in succession in FIG. 6 may in fact be executed substantially concurrently or the blocks may sometimes be executed in the reverse order, depending upon the functionality involved. Alternate implementations are included within the scope of the example embodiments in which functions may be executed out of order from that shown or discussed, including substantially concurrently or in reverse order, depending on the functionality involved.

The UE 104 may receive the at least one MAC-CE from the TRP 102, at step 602. The at least one MAC-CE may comprise at least one code-point. The at least one code-point may map to the at least one TCI state. The UE 104 may receive at least one of TCI field and signaling index in the at least one DCI from the TRP 102, at step 604. The TCI field may comprise at least one bit to indicate at least one code-point of the at least one MAC-CE. The UE 104 may activate the at least one TCI state based on at least one of the signaling index and the TCI field, at step 606. The UE 104 may perform at least one of the at least one DL reception and the at least one UL transmission using at least one TCI state activated, at step 608.

The signaling index may indicate the at least one TCI state corresponding to the at least one code-point indicated using the TCI field in the at least one DCI to the UE 104. The TRP 102 may signal the signaling index using at least one of the RRC and the MAC-CE based signalling. The at least one code-point may be mapped to the at least one TCI state from at least one of at least one joint/DL TCI state and at least one UL TCI state.

The TRP 102 may introduce a new DCI field which may requires (n+1) number of bits, where n=ceil(log₂(maximum number of TCI states per code-point)). The at least one bit out of the (n+1) bits may indicate the UE 104 whether the DCI is scheduling a single TRP PDSCH or a multi TRP PDSCH. The remaining bits may indicate the activated TCI states for the scheduled PDSCH. For example, if Most Significant Bit (MSB) or Least Significant Bit (LSB) of the (n+1) bit is 0 (or 1), then the PDSCH scheduled by the DCI may be a single TRP DCI. The remaining n bits may indicate one among the multiple TCI states activated by the code-point and the activated TCI state may be used for decoding the PDSCH scheduled by the DCI. If the MSB/LSB of the (n+1) bit is 1 (or 0), then the PDSCH scheduled by the DCI may be a multi TRP PDSCH. The UE 104 may ignore the remaining n bits and may use all the TCI states present in the code-point indicated by the TCI field in the DCI for receiving PDSCH.

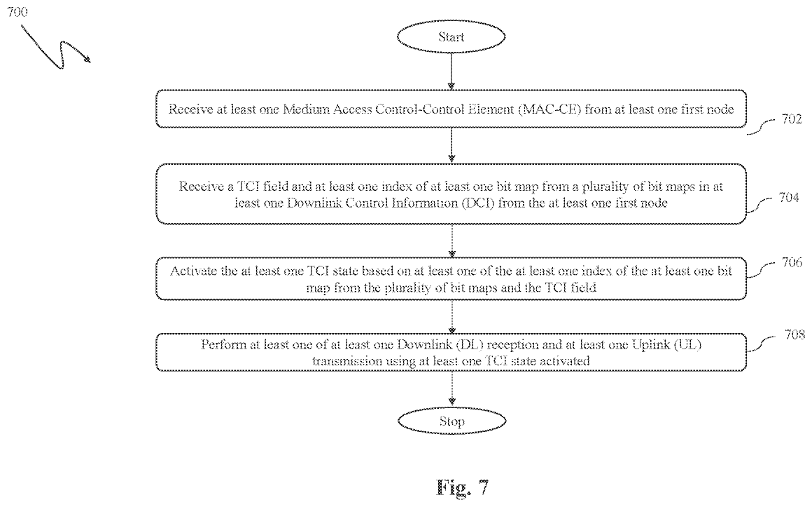

FIG. 7 illustrates a flow chart of a method for performing signaling in a multi TRP wireless communication system, in accordance with an embodiment of the present invention. It should also be noted that in some alternative implementations, the functions noted in the blocks may occur out of the order noted in the drawings. For example, two blocks shown in succession in FIG. 7 may in fact be executed substantially concurrently or the blocks may sometimes be executed in the reverse order, depending upon the functionality involved. Alternate implementations are included within the scope of the example embodiments in which functions may be executed out of order from that shown or discussed, including substantially concurrently or in reverse order, depending on the functionality involved.

The UE 104 may receive the at least one MAC-CE from the TRP 102, at step 702. The at least one MAC-CE may comprise at least one code-point. The at least one code-point may map to the at least one TCI state. The UE 104 may receive TCI field and at least one index of at least one bit map from a plurality of bit maps in the at least one DCI from the TRP 102, at step 704. The TCI field may comprise at least one bit to indicate at least one code-point of the at least one MAC-CE. The UE 104 may activate the at least one TCI state based on at least one of the at least one index of the at least one bit map from the plurality of bit maps and the TCI field, at step 706. The UE 104 may perform at least one of the at least one DL reception and the at least one UL transmission using at least one TCI state activated, at step 708.

The at least one index of the at least one bit map from the plurality of bit may indicate at least one of a single TRP and a multi TRP operation map implicitly or explicitly. The TRP 102 may signal the at least one bit map using at least one of the RRC and the MAC-CE based signaling. The length of the at least one bit map may be a maximum number of TCI states per code-point present in the at least one MAC-CE.

The TRP 102 may configure a look up table to the UE 104 through the RRC configuration. The look up table may consist of X number of rows, where X=2^{m}, where m=(maximum number of TCI states per code-point). The entries of the table may represent the bit map fields. The bit map field may indicate the subset of activated TCI states of the activated code-point in the MAC-CE. The length of bit map filed may be m bits.

The number of TCI states activated by the bit map may indicate whether it is a multi TRP operation or single TRP operation. If activated TCI states in bit map field is more than one, then TCI states may be applicable for multi TRP operation. If activated TCI states in bit map field is less than one, then TCI states may be applicable for single TRP operation. The TRP 102 may signal the index of each row from look up table in the DCI to the UE 104 for dynamically switching between single TRP operation and multi TRP operation. The UE 104 may map the bits of the bit map field to the activated TCI states of the activated code point in the MAC-CE based on the received index in the DCI.

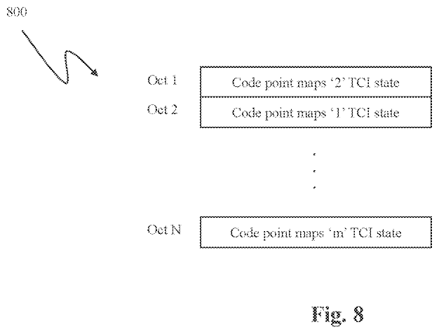

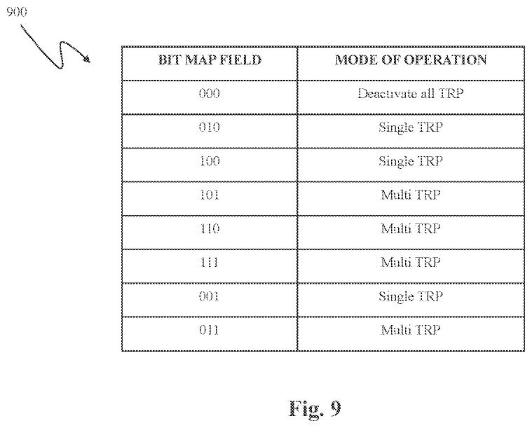

In the bit map field, the position of ones may represent TCI state(s) that are activated in configured code-point in the MAC-CE structure. When the number of TCI state(s) in any code-point may be less than the length of m bits, then the LSBs/MSBs of the bit map may be considered for activation of the TCI state(s). FIG. 8 illustrates Code point representation in MAC-CE structure, in accordance with an embodiment of the present invention. FIG. 9 illustrates a look up table, in accordance with an embodiment of the present invention. If the maximum number of TCI states per code-point is 3 as shown in FIG. 8, the code-point may map the TCI state(s) up to a maximum of 3 TCI states. Based on the configured value of maximum number of TCI states per code-point, the number of rows in the look up table may be determined as shown in FIG. 9.

Thus, the present invention relates to signaling methods for dynamically switching Transmission Configuration Indicator (TCI) states between single TRP operation and multi TRP operation in the wireless communication network 100 to provide better connection and network scheduling flexibility of the wireless communication system.

In the above detailed description, reference is made to the accompanying drawings that form a part thereof, and illustrate the best mode presently contemplated for carrying out the invention. However, such description should not be considered as any limitation of scope of the present invention. The structure thus conceived in the present description is susceptible of numerous modifications and variations, all the details may furthermore be replaced with elements having technical equivalence.

We claim:

1. A method for performing signaling in a multi Transmission/Reception Point (TRP) wireless communication system, the method comprising:
receiving, by at least one second node (104), at least one Medium Access Control-Control Element (MAC-CE) from at least one first node (102), wherein the at least one MAC-CE comprises at least one code-point, wherein the at least one code-point maps to at least one Transmission Configuration Indicator (TCI) state;
receiving, by the at least one second node (104), at least one of a flag and TCI field in at least one Downlink Control Information (DCI) from the at least one first node (102), wherein the flag comprises at least one bit to indicate one of a single TRP and a multi TRP operation from the at least one first node (102), wherein the TCI field comprises at least one bit to indicate the at least one code-point of the at least one MAC-CE;
activating, by the at least one second node (104), the at least one TCI state based on at least one of the flag and the TCI field; and
performing, by the at least one second node (104), at least one of at least one Downlink (DL) reception and at least one Uplink (UL) transmission using at least one TCI state activated.

2. The method as claimed in claim 1, wherein the MAC-CE is at least one of a single TRP MAC-CE and a multiple TRP MAC-CE.

3. The method as claimed in claim 1, wherein the at least one TCI state belongs to a unified TCI state.

4. The method as claimed in claim 1, wherein the at least one DL reception is at least one of Physical Downlink Control Channel (PDCCH), Physical Downlink Shared Channel (PDSCH), and DL reference signals.

5. The method as claimed in claim 1, wherein the at least one UL transmission is at least one of Physical Uplink Control Channel (PUCCH), Physical Uplink Shared Channel (PUSCH), and UL reference signals.

6. The method as claimed in claim 1, wherein the at least one code-point of the at least one MAC-CE is mapped to the at least one of one TCI state, two TCI states, three TCI states and four TCI states.

7. The method as claimed in claim 6, wherein the at least one code-point is mapped to the at least one TCI state from at least one of at least one joint/DL TCI states and at least one UL TCI state.

8. The method as claimed in claim 1, wherein the at least one MAC-CE comprises at least one of serving cell identity (ID), Bandwidth Part Indicator (BWP ID), at least one Reserved bit (R) field, at least one joint/DL TCI state ID field, at least one UL TCI state ID field, at least one Aᵢ field and at least one D/Uᵢ field, at least one B_{i,j} field, at least one Cᵢ field, and at least one D_{i,j} field.

9. The method as claimed in claim 8, wherein the at least one code-point of the at least one MAC-CE is applied to the BWP ID comprising at least one of DL BWP and UL BWP.

10. The method as claimed in claim 8, wherein the at least one Ai field indicates whether i^{th} TCI code-point maps to any one of single and multiple TCI states from at least one of the at least one joint/DL TCI state and the at least one UL TCI state.

11. The method as claimed in claim 8, wherein the at least one D/Uᵢ field indicates whether i^{th} TCI code-point maps to at least one TCI state from at least one of the at least one joint/DL TCI state and the at least one UL TCI state.

12. The method as claimed in claim 1, wherein at least one code-point is determined by its ordinal position among all TCI state fields.

13. The method as claimed in claim 8, wherein the at least one B_{i,j} field indicates at least one code-point indicating at least one UL TCI state ID field is present.

14. The method as claimed in claim 8, wherein the at least one Cᵢ field indicates at least one code-point indicating at least one joint/DL TCI state ID field is present.

15. The method as claimed in claim 8, wherein the at least one D_{i,j} field indicates whether preceding octet is one of padding octet and the at least one joint/DL TCI state.

16. The method as claimed in claim 8, wherein the at least one joint/DL TCI state ID field indicates the at least one joint/DL TCI state from a plurality of joint/DL TCI states configured for the at least one second node (104).

17. The method as claimed in claim 8, wherein the at least one UL TCI state ID field indicates the at least one UL TCI state from a plurality of UL TCI states configured for the at least one second node (104).

18. A method for performing signaling in a multi Transmission/Reception Point (TRP) wireless communication system, the method comprising:
receiving, by at least one second node (104), at least one Medium Access Control-Control Element (MAC-CE) from at least one first node (102), wherein the at least one MAC-CE comprises at least one code-point, wherein the at least one code-point maps to at least one Transmission Configuration Indicator (TCI) state;
receiving, by the at least one second node (104), at least one of TCI field and TCI selection field in at least one Downlink Control Information (DCI) from the at least one first node (102), wherein the TCI field comprises at least one bit to indicate the at least one code-point of the at least one MAC-CE;
activating, by the at least one second node (104), the at least one TCI state based on at least one of the TCI field and the TCI selection field; and
performing by the at least one second node (104), at least one of at least one Downlink (DL) reception and at least one Uplink (UL) transmission using the at least one TCI state activated.

19. The method as claimed in claim 18, wherein the TCI selection field indicates the at least one TCI state corresponding to the at least one code-point indicated using the TCI field in the DCI to the at least one second node (104).

20. The method as claimed in claim 19, wherein the TCI selection field implicitly or explicitly indicates at least one of a single TRP operation and a multi TRP operation.

21. The method as claimed in claim 19, wherein the TCI selection field is signaled using at least one of Radio Resource Control (RRC) and Medium Access Control-Control Element (MAC-CE) based signaling.

22. The method as claimed in claim 19, wherein the TCI selection field is a bit map with length of maximum number of TCI states per code-point present in the at least one MAC-CE.

23. The method as claimed in claim 18, wherein the at least one code-point is mapped to the at least one TCI state from at least one of at least one joint/DL TCI state and at least one UL TCI state.

24. The method as claimed in claim 23, wherein the at least one TCI state applies to at least one of the at least one UL transmission and at least one DL reception.

25. The method as claimed in claim 24, wherein the at least one DL reception and the at least one UL transmission is at least one of Physical Downlink Control Channel (PDCCH), Physical Downlink Shared Channel (PDSCH), Physical Uplink Control Channel (PUCCH), Physical Uplink Shared Channel (PUSCH) and at least one reference signal.

26. The method as claimed in claim 18, wherein the at least one TCI state belongs to a unified TCI state.

27. A method for performing signaling in a multi Transmission/Reception Point (TRP) wireless communication system, the method comprising:
receiving, by at least one second node (104), at least one Medium Access Control-Control Element (MAC-CE) from at least one first node (102), wherein the at least one MAC-CE comprises at least one code-point, wherein the at least one code-point maps to at least one Transmission Configuration Indicator (TCI) state;
receiving, by the at least one second node (104), at least one of TCI field and signaling index in at least one Downlink Control Information (DCI) from the at least one first node (102), wherein the TCI field comprises at least one bit to indicate at least one code-point of the at least one MAC-CE;
activating, by the at least one second node (104), the at least one TCI state based on at least one of the signaling index and the TCI field; and
performing, by the at least one second node (104), at least one of at least one Downlink (DL) reception and at least one Uplink (UL) transmission using the at least one TCI state activated.

28. The method as claimed in claim 27, wherein the signaling index indicates the at least one TCI state corresponding to the at least one code-point indicated using the TCI field in the at least one DCI to the at least one second node (104).

29. The method as claimed in claim 28, wherein the signaling index is signaled using at least one of Radio Resource Control (RRC) and Medium Access Control-Control Element (MAC-CE) based signaling.

30. The method as claimed in claim 27, wherein the at least one code-point is mapped to the at least one TCI state from at least one of at least one joint/DL TCI state and at least one UL TCI state.

31. The method as claimed in claim 30, wherein the at least one TCI state applies to at least one of the at least one DL reception and the at least one UL transmission.

32. The method as claimed in claim 31, wherein the at least one DL reception and the at least one UL transmission is at least one of Physical Downlink Control Channel (PDCCH), Physical Downlink Shared Channel (PDSCH), Physical Uplink Control Channel (PUCCH), Physical Uplink Shared Channel (PUSCH), and at least one reference signal.

33. The method as claimed in claim 27, wherein the length of the signaling index is (n+1), where n=log₂(maximum number of TCI states in the at least one code-point).

34. The method as claimed in claim 33, wherein at least one bit in the signaling index implicitly or explicitly indicates one of a single TRP operation and a multi TRP operation.

35. The method as claimed in claim 34, wherein for explicit indication, the at least one bit is a Most Significant Bit (MSB) or a Least Significant Bit (LSB) of the (n+1) bits.

36. The method as claimed in claim 33, wherein when the single TRP operation is indicated, remaining bits in the signaling index activates the at least one TCI state corresponding to the at least one code-point in the at least one DCI.

37. The method as claimed in claim 28, wherein when the multi TRP operation is indicated, the remaining bits in the signaling index activate all TCI states corresponding to the at least one code-point indicated by the TCI field in the at least one DCI.

38. The method as claimed in claim 27, wherein the at least one TCI state belongs to a unified TCI state.

39. A method for performing signaling in a multi Transmission/Reception Point (TRP) wireless communication system, the method comprising:
receiving, by at least one second node (104), at least one Medium Access Control-Control Element (MAC-CE) from at least one first node (102), wherein the at least one MAC-CE comprises at least one code-point, wherein the at least one code-point maps to at least one Transmission Configuration Indicator (TCI) state;
receiving, by the at least one second node (104), a TCI field and at least one index of at least one bit map from a plurality of bit maps in at least one Downlink Control Information (DCI) from the at least one first node (102), wherein the TCI field comprises at least one bit to indicate the at least one code-point of the at least one MAC-CE;
activating, by the at least one second node (104), the at least one TCI state based on at least one of the at least one index of the at least one bit map from the plurality of bit maps and the TCI field; and
performing, by the at least one second node (104), at least one of at least one Downlink (DL) reception and at least one Uplink (UL) transmission using the at least one TCI state activated.

40. The method as claimed in claim 39, wherein the at least one bit map indicates the at least one TCI state corresponding to the code-point indicated using TCI field in the at least one DCI to the at least one second node (104).

41. The method as claimed in claim 40, wherein the at least one index of the at least one bit map from the plurality of bit map implicitly or explicitly indicates at least one of a single TRP and a multi TRP operation.

42. The method as claimed in 40, wherein the at least one bit map is signaled using at least one of Radio Resource Control (RRC) and Medium Access Control-Control Element (MAC-CE) based signaling.

43. The method as claimed in claim 40, wherein length of the at least one bit map is maximum number of TCI states per code-point present in the at least one MAC-CE.

44. The method as claimed in claim 39, wherein the at least one code-point is mapped to the at least one TCI state from at least one of at least one joint/DL TCI state and at least one UL TCI state.

45. The method as claimed in claim 44, wherein the at least one TCI state applies to at least one of the at least one DL reception and the at least one UL transmission.

46. The method as claimed in claim 45, wherein the at least one DL reception and the at least one UL transmission is at least one of Physical Downlink Control Channel (PDCCH), Physical Downlink Shared Channel (PDSCH), Physical Uplink Control Channel (PUCCH), Physical Uplink Shared Channel (PUSCH), and at least one reference signal.

47. The method as claimed in claim 40, wherein position of bits in the at least one bitmap field represents the at least one TCI state activated.

48. The method as claimed in claim 39, wherein the at least one TCI state belongs to a unified TCI state.
